(19) United States
(12) Patent Application Publication
(10) Pub. No.: US 2009/0100162 A1
(43) Pub. Date: Apr. 16, 2009

(54) Sharing Policy and Workload among Network Access Devices

(75) Inventors: Vladimir Holostov, Hadera (IL); Yury Berezansky, Haifa (IL); Zvi Avidor, Haifa (IL)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/872,175

(22) Filed: Oct. 15, 2007

(51) Int. Cl. G06F 15/16

(52) U.S. Cl. 709/223

(57) ABSTRACT

Aspects of the subject matter described herein relate to sharing policy and workload among network access devices. In aspects, a network access device receives a communication between a first and a second node. The network access device may be one of a set of network access devices responsible for processing traffic to and from a set of nodes. A network access device determines a policy to apply to the communication and at least one network device to apply the policy. The determination of the at least one network device to apply the policy may include determining which network access devices are capable of applying the policy as well as the workload on the network access devices.

### BACKGROUND

A company may use a network access device such as a firewall or proxy server to provide access to a network. A company with more than one location may have one or more network access devices at each location. Often, traffic is routed through two or more network access devices, each configured to enforce certain security policy, perform content rendering, or perform other processing on the traffic. This may cause duplication of work by the network access devices at each location, overloading of a particular network access device, inadequate policy enforcement, and/or inconsistency.

### SUMMARY

Briefly, aspects of the subject matter described herein relate to sharing policy and workload among network access devices. In aspects, a network access device receives a communication between a first and a second node. The network access device may be one of a set of network access devices responsible for processing traffic to and from a set of nodes. A network access device determines a policy to apply to the communication and at least one network device to apply the policy. The determination of the at least one network device to apply the policy may include determining which network access devices are capable of applying the policy as well as the workload on the network access devices.

This Summary is provided to briefly identify some aspects of the subject matter that is further described below in the Detailed Description. This Summary is not intended to identify key or essential features of the claimed subject matter, nor is it intended to be used to limit the scope of the claimed subject matter.

The phrase “subject matter described herein” refers to subject matter described in the Detailed Description unless the context clearly indicates otherwise. The term “aspects” is to be read as “at least one aspect.” Identifying aspects of the subject matter described in the Detailed Description is not intended to identify key or essential features of the claimed subject matter.

The aspects described above and other aspects of the subject matter described herein are illustrated by way of example and not limited in the accompanying figures in which like reference numerals indicate similar elements and in which:

### BRIEF DESCRIPTION OF THE DRAWINGS

FIG. 1 is a block diagram representing an exemplary general-purpose computing environment into which aspects of the subject matter described herein may be incorporated;

FIG. 2 is a block diagram representing an exemplary environment in which aspects of the subject matter described herein may be implemented;

FIG. 3 is a block diagram illustrating various components associated with a network access device in accordance with aspects of the subject matter described herein; and

FIGS. 4-5 are flow diagrams that generally represent exemplary actions that may occur in enforcing policies in accordance with aspects of the subject matter described herein.

### DETAILED DESCRIPTION

### Exemplary Operating Environment

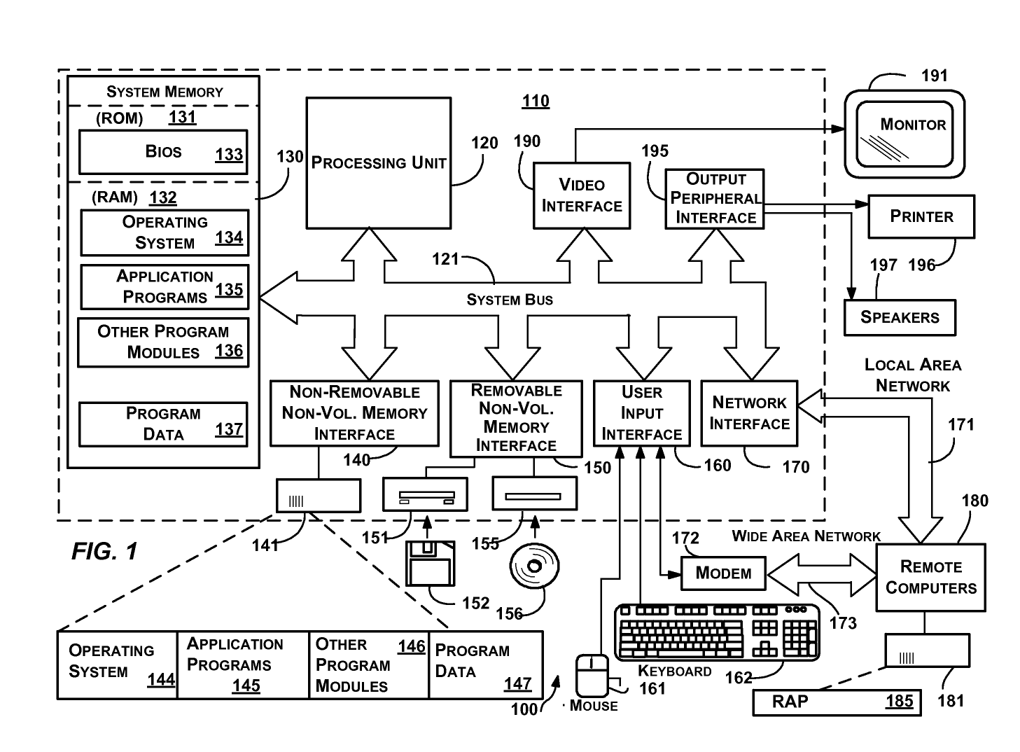

FIG. 1 illustrates an example of a suitable computing system environment 100 on which aspects of the subject matter described herein may be implemented. The computing system environment 100 is only one example of a suitable computing environment and is not intended to suggest any limitation as to the scope of use or functionality of aspects of the subject matter described herein. Neither should the computing environment 100 be interpreted as having any dependency or requirement relating to any one or combination of components illustrated in the exemplary operating environment 100.

Aspects of the subject matter described herein are operational with numerous other general purpose or special purpose computing system environments or configurations. Examples of well known computing systems, environments, and/or configurations that may be suitable for use with aspects of the subject matter described herein include, but are not limited to, personal computers, server computers, hand-held or laptop devices, multiprocessor systems, microcontroller-based systems, set top boxes, programmable consumer electronics, network PCs, minicomputers, mainframe computers, distributed computing environments that include any of the above systems or devices, and the like.

Aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing aspects of the subject matter described herein includes a general-purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile discs (DVDs) or other optical disk storage, magnetic cassettes, magnetic tape, magnetic disk storage or other magnetic storage devices, or any other medium which can be used to store the desired information and which can be accessed by the computer 110. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. In one embodiment, combinations of any of the above are also included within the scope of computer-readable media. In another embodiment, a computer-readable comprises storage media but not communication media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disc drive 155 that reads from or writes to a removable, nonvolatile optical disc 156 such as a CD ROM or other optical media. Other removable/non-removable, volatile/nonvolatile computer storage media that can be used in the exemplary operating environment include, but are not limited to, magnetic tape cassettes, flash memory cards, digital versatile discs, digital video tape, solid state RAM, solid state ROM, and the like. The hard disk drive 141 is typically connected to the system bus 121 through a non-removable memory interface such as interface 140, and magnetic disk drive 151 and optical disc drive 155 are typically connected to the system bus 121 by a removable memory interface, such as interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, a touch-sensitive screen of a handheld PC or other writing tablet, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

### Sharing Policy and Workload

As mentioned previously, network access devices may be spread throughout an organization. Some traffic may pass through more than one network access device before reaching its final destination. This may cause duplication of work, overloading of a particular network device, inadequate policy enforcement, inconsistency, and other problems.

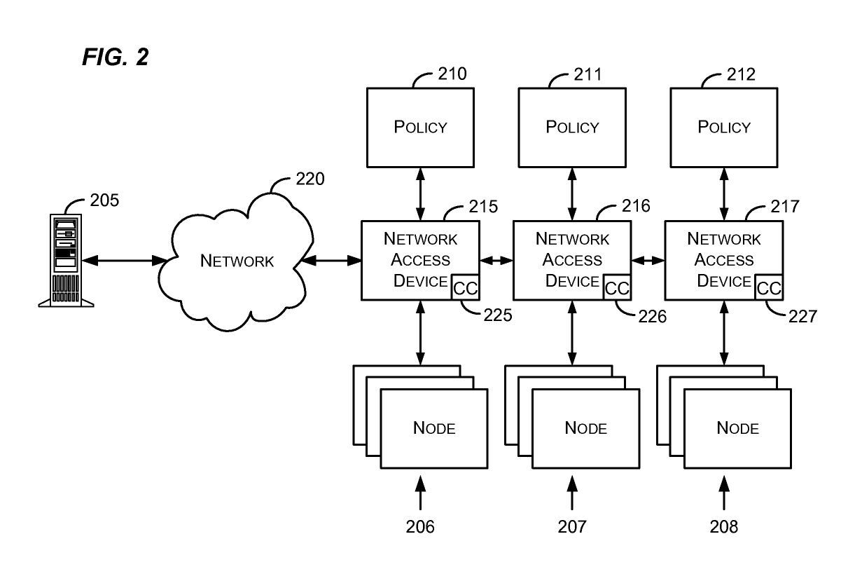

FIG. 2 is a block diagram representing an exemplary environment in which aspects of the subject matter described herein may be implemented. The environment includes nodes 205-208, policies 210-212, network access devices 206-208, a network 220 and may include other entities (not shown). The various entities may communicate with each other via various networks including intra- and inter-office networks and the network 220. Where a line connects one entity to another, it is to be understood that the two entities may be connected via any type of network including a direct connection, a local network, a non-local network, a network such as the network 220, the Internet, some combination of the above, and the like.

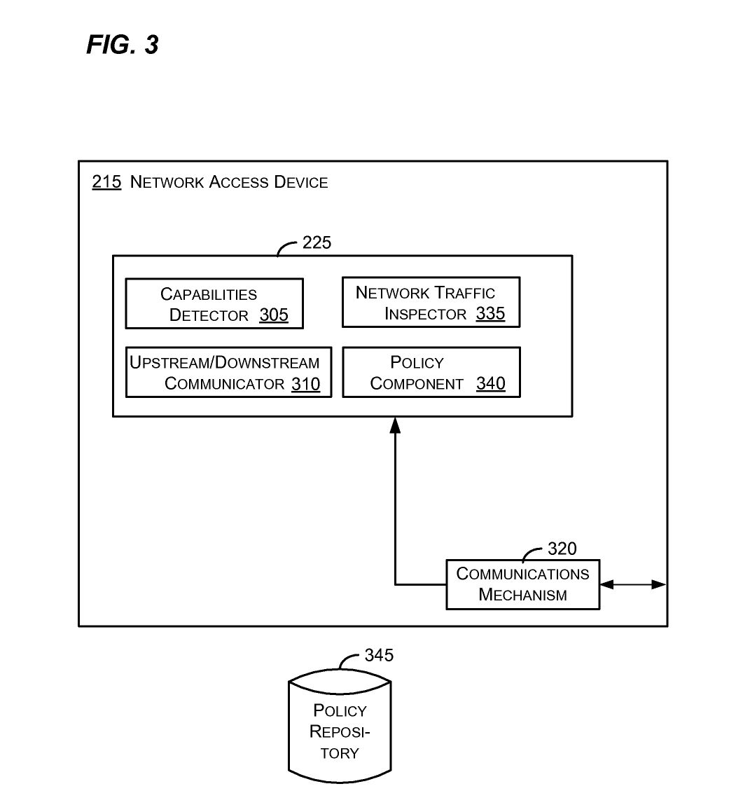

In an embodiment, the network 220 may comprise the Internet. In an embodiment, the network 220 may comprise one or more private networks, virtual private networks, and the like. The network access devices 206-208 may include or have access to coordinating components 225-227, respectively. The coordinating components are described in more detail in conjunction with FIG. 3.

Each of the nodes 205-208 may be implemented on or as one or more computers (e.g., the computer 110 as described in conjunction with FIG. 1). The nodes 206 may comprise one or more nodes that access a network through the network access device 215. Although the nodes 206 may access the network through the network access device 215, this does not necessarily mean that the access policy is identical for each of the nodes of the nodes 206. Indeed, any node of the nodes 206 may have a similar, identical, or vastly different access policy than any other node of the nodes 206.

Similarly, the nodes 207 and 208 may comprise one or more nodes that access a network through the network access devices 216 and 217, respectively. The node 205 may be located at any location accessible through the network 220 or may even be located on a network that is local to one of the nodes 206-208. In today's world, this location may be at a data center, at a company website, on a user's desktop computer, or in some other place to name a few locations.

The node 205 may comprise any device that is capable of communicating with one or more of the nodes 206-208. The node 205 may perform the role of a server, a peer, and/or a client and may switch from one role to another.

The network 220 (or at least the links from the entities to the network 220) may be a relatively slow and bandwidth limited network, although aspects of the subject matter described herein may also be applied to high speed and high bandwidth networks. Indeed, there is no intention to limit aspects of the subject matter described herein to just low bandwidth or high latency networks. Furthermore, it will be recognized by those skilled in the art that aspects of the subject matter may be employed between any two entities connected by any type of network.

The network access devices 215-217 may comprise firewalls, routers, computers (e.g., such as the computer 110 of FIG. 1), or the like. Each network access device may process network traffic to and from the nodes and other devices connected to it. Processing network traffic may involve taking actions on the network traffic including blocking the traffic, forwarding the traffic, re-routing the traffic, traffic modification including, for example, rescaling an image sent via the traffic, removing malware from the traffic, and the like. Some exemplary network traffic processing includes antivirus inspection, image analysis to detect adult content, for example, detecting content type, information leak protection, and the like.

The above examples are not intended to be exhaustive of the various types of network traffic processing that may occur on a network access device. Rather, they are intended to indicate some of the many types of traffic processing that may occur on a network access device. Those skilled in the art will recognize many other types of network traffic processing that may also occur on a network access device without departing from the spirit or scope of aspects of the subject matter described herein.

A network access device may generate metadata during traffic processing. For example, a network access device may classify a file or image transmitted via the traffic. As another example, a network access device may determine that a file is infected with malware. As yet another example, a network access device may determine the size of content, the type of content, or some other characteristic of the content. A network access device may transmit this metadata to another network access device. The other network access device may use this information as appropriate to, for example, allow or block the traffic, clean the content, take another action, and the like.

A network access device may also enforce policies with respect to network usage. A policy may specify actions to be take to process or filter out network traffic. A policy may be expressed as a set of one or more rules. A rule may be expressed by a predicate, one or more actions to take if the predicate is true, and/or one or more an actions to take if the predicate is false. A predicate may involve zero or more conditions zero or more of which may need to be satisfied for the predicate to be true.

As an example, an antivirus policy may indicate the following actions:

1. Scan all content with two antivirus engines;

2. Bias scanning for certainty above performance;

3. Block files larger than 2 GB and encrypted archives;

4. Attempt to repair infected files;

5. Always use latest signatures during scanning; and

6. Block traffic if an inspection cannot be performed.

The example policy above is not intended to be all-inclusive or exhaustive. Indeed, a policy may be created for almost any conceivable set of conditions without departing from the spirit or scope of aspects of the subject matter described herein.

The policies 210-212 may be stored in local or remote storage. In one embodiment, the policies are collocated on a central storage device that each of the network access devices 215-217 can access to obtain applicable policies. In another embodiment, the policies 210-212 are distributed across two or more storage devices. In yet another embodiment, the policy 210 is stored in a storage device local to the network access device 215 while the policies 211 and 212 are stored in storage devices local to the network access devices 216-217, respectively. Indeed, the policies 210-212 may be stored virtually anywhere without departing from the spirit or scope of aspects of the subject matter described herein.

In operation, network access devices may establish a trust relationship with each other. A trust relationship may be one-way or two-way. A trust relationship allows the network access devices to securely share policies, capabilities, and metadata and to divide the workload. For example, once a trust relationship is established, the network access devices 215-217 may securely share the policies 210-212 with each other. A trust relationship may be achieved in a number of different ways including sharing public and/or private keys between devices.

When a network access device receives network traffic, the network access device identifies the appropriate policy to apply for processing. In one embodiment, the network device associated with a node affected by a policy determines whether the policy is to be applied to the node. For example, the network access device 217 may determine whether the policy 212 is to be applied to the nodes 208. Once this decision is made, the policy, or any part of it, may be applied by any network device that is capable of applying the policy. For example, if the network access device 217 determines that the policy 212 is to be applied to a node, the network access device 215 may apply a portion or all of the policy 212. A network access device through which traffic flows may also apply any additional policies. For example, if traffic from the node 205 is directed to one of the nodes 208, the network access device 215 may apply policy 210 to the traffic as well as the policy 212.

A system administrator or the like may indicate policies that are to be applied based on the nodes to which the traffic is directed. These policies may be applied regardless of traffic routing while leaving where to apply the policies up to the network access devices. For example, if network traffic is directed to the nodes 207, the policies 210 and 211 may be applied to the network traffic. As another example, if network traffic is directed to the nodes 208, the policies 211 and 212 may be applied to the network traffic.

In one embodiment, the most restrictive policies of any of the network devices through which the traffic will pass en route to its destination are applied. For example, policy 210 may indicate that any files under 5 GB are acceptable, policy 211 may indicate that any files under 2 GB are acceptable, and policy 212 may indicate that any files under 8 GB are acceptable. In this example, if one of the nodes 208 attempts to download a file over 2 GB, the network traffic may be cut off as this is not allowed by a policy of an upstream network device (e.g., the network access device 216). On the other hand, if one of the nodes 207 attempts to download a 1 GB file, this may be allowed as this is less than the policies 210 and 211 associated with the network access devices 215-216 through which the traffic will pass to get to the node.

In another embodiment, the policies may be enforced in a manner such that they are partially or fully independent of each other. For example, if the policy 211 indicates that a node may download an 8 GB file and the policy 210 indicates that a node may download a 2 GB file, the nodes 207 may be allowed to download 8 GB files even though these files may pass through both of the network access devices 215 and 216.

In another embodiment, a combination of policies of any of the network devices through which the traffic will pass en route to its destination is applied. For example, if one policy indicates that files under 5 GB are acceptable and another policy indicates that the files need to be scanned, files under 5 GB are allowed after they are scanned.

In another embodiment, policies may be merged in a manner determined by a system administrator. The system administrator may determine for each policy whether the policy is to be affected by upstream policies that may be more restrictive.

As mentioned previously, policy may be stored centrally, locally, or in some other fashion. In one embodiment, when a network access device does not know what policy to apply, the network access device may query other network access devices to discover the relevant policy to apply.

Traffic processing may be distributed among the available network access devices. This may involve determining capabilities and relative workloads of network access devices. Capabilities and relative workloads of network access devices may be conveyed out-of-band, combined with regular network traffic, or may be conveyed using some combination of the above. If a network device does not have the capability of performing the desired traffic processing, another network device that does have the capability may be used to perform the traffic processing. If more than one network access device has the capability to perform a desired traffic processing, the network access device having the least load may perform the traffic processing. Other load balancing mechanisms may also be used without departing from the spirit or scope of aspects of the subject matter described herein.

Capability discovery may include determining if a network access device has the needed engines, (e.g., an antivirus engine), components, and/or processes to perform network processing dictated by policy. Capability discovery may also involve determining whether other conditions specified by a policy are available on a network access device. For example, if a policy indicates that virus scanning be done with the most current virus signatures, a network access device that does not have the most current virus signatures may not be allowed to scan the network traffic for viruses to apply the policy.

For example, the network access devices 216 and 217 may both have an antivirus engine and the network access device 216 may be the idlest but the network access device 217 may have newer signatures than the network access device 216. If a policy indicates that the newest signatures are to be used, the network access device 217 may be used to perform antivirus scanning. As another example, the network access device 217 may rescan traffic that was already performed by the network accesses devices 215 or 216 if their anti-virus signatures are older which may be indicated, for example, in a timestamp of latest anti-virus signature that is passed from the network access devices 215 and/or 216.

Certain network processing may be performed on one network access device while other network processing is performed on another network device. For example, one network access device may detect that content includes malware while another network device may attempt to remove the malware. To support this, the results of traffic process by one network access device may be passed from one network access device to another via metadata.

Although the environment described above includes three network access devices and nodes in various configurations, it will be recognized that more, fewer, and/or a different combination of these and other entities may be employed without departing from the spirit or scope of aspects of the subject matter described herein. Furthermore, the entities and communication networks included in the environment may be configured in a variety of ways as will be understood by those skilled in the art without departing from the spirit or scope of aspects of the subject matter described herein.

FIG. 3 is a block diagram illustrating various components associated with a network access device in accordance with aspects of the subject matter described herein. The components illustrated in FIG. 3 are exemplary and are not meant to be all-inclusive of components that may be needed or included. In other embodiments, the components or functions described in conjunction with FIG. 3 may be included in other components or placed in subcomponents without departing from the spirit or scope of aspects of the subject matter described herein.

Turning to FIG. 3, the network access device 215 may include coordinating components 225 and a communications mechanism 320. The coordinating components 226 and 227 of FIG. 2 may be similar or identical to the coordinating components 225 of the network access device 215.

The coordinating components 225 may include a capabilities detector 305, an upstream/downstream communicator 310, a network traffic inspector 335, and a policy component 340. Although in one embodiment, the coordinating components 225 may reside on the network access device 215, in other embodiments, one or more of these components may reside on other devices. For example, one or more of these components may be provided as services by one or more other devices. In this configuration, the network access device 215 may cause the functions of these components to be performed by interacting with the services on the one or more other devices and providing pertinent information.

The network access device 215 may have access to a policy store 345. The store 345 may comprise a database, file, data structure, code, rules, a combination of the above, and or the like that defines policies. The store 345 may include policies that may be used by the network traffic inspector 335 to enforce policies. These policies may be located centrally or may be distributed over several devices as described previously. These policies may be changed when desired by a system administrator or the like.

The upstream/downstream communicator 310 may be operable to communicate with upstream and downstream network access devices. An upstream network device receives a communication some time before the communication is received by the network access device 215. A downstream network device receives a communication some time after the communication is received by the network access device 215. For example, referring to FIG. 2, if the node 205 sent a communication to one of the nodes 208, the network access device 215 is an upstream device to the network access device 216. Furthermore, the network access device 216 is an upstream device to the network access device 217 and is a downstream device to the network access device 215.

Also note that a device that is an upstream device for one part of a communication may be a downstream device for another part of the communication or another communication. For example, with HTTP, a request message is sent by a client to a server, and a response message is sent in the reverse direction. Referring to FIG. 2, if one of the nodes 208 is the client and the node 205 is the server, for the first part of the communication (i.e., the request), the network access device 217 is upstream from the network access device 216 which is upstream from the network access device 215 while for the second part of the communication (i.e., the response), the network access device 215 is upstream from the network access device 216 which is upstream from the network access device 217.

Among other things, the upstream/downstream communicator 310 may send and receive network traffic processing capabilities, metadata regarding a communication, requests to perform traffic processing, other information, and the like to another entity such as an upstream or downstream network access device. The upstream/downstream communicator may be further operable to determine whether the network access device 215 is to process the communication according to a policy or whether a different network access device is to do so.

The policy component 340 may be operable to determine a policy to apply to a communication. For example, the policy component 340 may determine that the communication is to be scanned by two antivirus scanning engines.

The network traffic inspector 335 may operate to examine the communication and apply the policy to the communication as appropriate. Communication as used herein means any portion of a communication (e.g., a single packet) or a complete communication (e.g., a transmitted file, content, set of packets, and the like) between two nodes.

In one embodiment, one or more components on a requesting node may perform the functions of the coordinating components 225 of the network access device 215 for the particular requesting node. For example, in one embodiment, the one or more components on the requesting node may be called by a network stack of a requesting node. These components may perform similarly to how the coordinating components 225 perform except on a single node basis. This may be used for a requester that may not use the network access device 215 to request content. In this configuration, the one or more components on the requesting node may seamlessly examine communications and enforce policies as needed without employing a separate network access device 215.

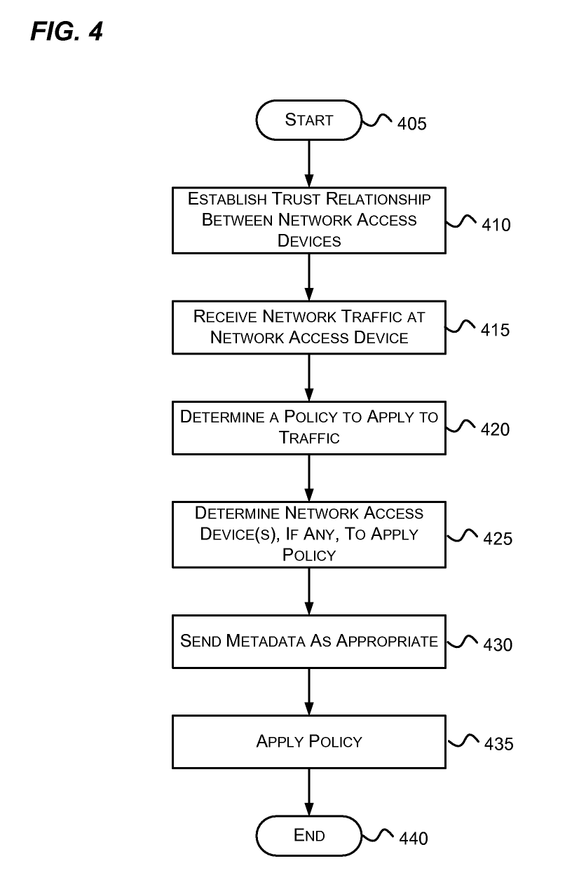

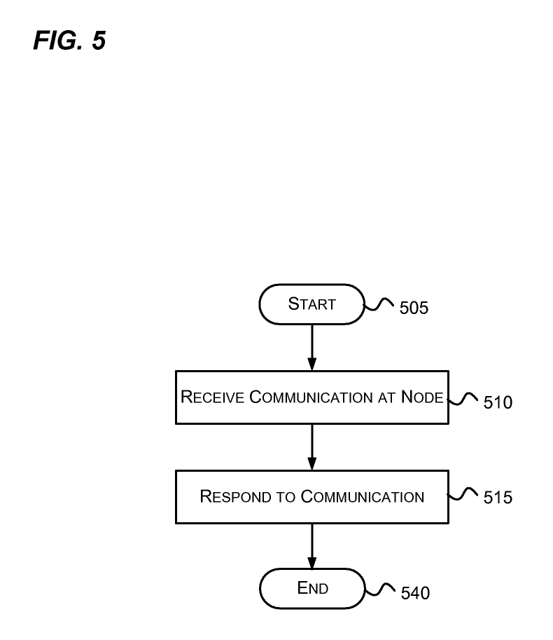

FIGS. 4-5 are flow diagrams that generally represent exemplary actions that may occur in enforcing policies in accordance with aspects of the subject matter described herein. For simplicity of explanation, the methodology described in conjunction with FIGS. 4-5 is depicted and described as a series of acts. It is to be understood and appreciated that aspects of the subject matter described herein are not limited by the acts illustrated and/or by the order of acts. In one embodiment, the acts occur in an order as described below. In other embodiments, however, the acts may occur in parallel, in another order, and/or with other acts not presented and described herein. Furthermore, not all illustrated acts may be required to implement the methodology in accordance with aspects of the subject matter described herein. In addition, those skilled in the art will understand and appreciate that the methodology could alternatively be represented as a series of interrelated states via a state diagram or as events.

Turning to FIG. 4, at block 405, the actions begin. At block 410, a trust relationship is established between network access devices. For example, referring to FIG. 2, the network access device 216 may authenticate the network access device 216, the network access device 216 may authenticate the network access devices 215 and 217, and the network access device 217 may authenticate the network access device 216. In addition, the network access devices may create secure channels between each other, use encryption to encode communications, and/or use other security features to ensure that data is not corrupted or tampered with.

At block 415, a network access device receives network traffic. For example, referring to FIG. 2, the network access device 215 receives a packet sent from the node 205 and directed to one of the nodes 207.

At block 420, a determination is made as to a policy to apply to the traffic. In conjunction with determining a policy to apply, the network access device may obtain the policy as described previously. For example, referring to FIG. 2, the network access device 215 may determine that the communication is to be scanned by an anti-virus scanner having the most up-to-date signatures.

At block 425, a determination is made as to which network access device(s), if any, to apply the policy. This determination may be based on which network access devices have the capabilities to apply the policy as well as the workloads on each of the network access devices as has been described previously. In one embodiment, the determination may include a real-time exchange of information between involved network access devices in which one or more of the devices may determine one or more preferable devices for applying the policy.

At block 430, metadata is sent as appropriate to the network access device(s) that are going to apply the policy. For example, referring to FIG. 2, if the network access device 215 is scanning for a virus and the network access device is to attempt to clean a file of any found virus, then the network access device 215 may send an indication of the found virus to the network access device 216.

At block 435, the policy is applied. For example, referring to FIG. 2, the network access device 215 may scan the communication for a virus.

At block 440, the actions end.

Turning to FIG. 5, at block 505, the actions begin. At block 510, a communication is received at a node. For example, referring to FIG. 2, one of the nodes 208 may receive a communication from the node 205.

At block 515, the node responds to the communication. Responding may comprise acknowledging receipt of the communication and does not necessarily mean communicating back to the sender of the communication. For example, a node may respond to a communication by buffering or storing data sent by the communication.

At block 520, the actions end.

As can be seen from the foregoing detailed description, aspects have been described related to sharing policy and workload among network access devices. While aspects of the subject matter described herein are susceptible to various modifications and alternative constructions, certain illustrated embodiments thereof are shown in the drawings and have been described above in detail. It should be understood, however, that there is no intention to limit aspects of the claimed subject matter to the specific forms disclosed, but on the contrary, the intention is to cover all modifications, alternative constructions, and equivalents falling within the spirit and scope of various aspects of the subject matter described herein.

What is claimed is:

1. A computer-readable medium having computer-executable instructions, which when executed perform actions, comprising:
receiving, at a network access device, a communication between a first and a second node, the network access device being part of a plurality of network access devices that are responsible for processing traffic to and from a set of nodes that includes the second node, at least one of the network access devices being downstream from at least one of the other network access devices;
determining a policy to apply to the communication; and
determining at least one of the network access devices to apply the policy.

2. The computer-readable medium of claim 1, wherein determining a network access device to apply the policy comprises determining capabilities of the network access devices and determining one or more network access devices that are capable of applying the policy to the communication.

3. The computer-readable medium of claim 1, wherein determining a network access device to apply the policy comprises determining a workload on one or more of the network access devices.

4. The computer-readable medium of claim 3, wherein determining a network access device to apply the policy further comprises determining a network access device that is least loaded and capable of applying the policy to apply the policy.

5. The computer-readable medium of claim 1, wherein the network access devices are distributed in a hierarchical fashion, such that for at least one of the set of nodes, a communication travels through two or more of the network access devices to come from or go to the first node.

6. The computer-readable medium of claim 1, further comprising establishing a trust relationship between two or more of the network access devices.

7. The computer-readable medium of claim 1, further comprising retrieving the policy from a central repository at which policies related to the set of nodes are stored.

8. The computer-readable medium of claim 1, further comprising querying one or more of the network access devices to obtain the policy.

9. The computer-readable medium of claim 1, wherein determining at least one of the network access devices to apply the policy comprises determining a first network access device to apply a first portion of the policy and determining a second network access device to apply a second portion of the policy.

10. The computer-readable medium of claim 9, further comprising passing metadata about the communication from the first network access device to the second network access device.

11. A method implemented at least in part by a computer, the method comprising:
receiving a communication at a node, the communication having passed through a network access device that is part of a plurality of network devices responsible for applying a policy to the communication, a first one of the network access devices being downstream from a second one of the network access devices, the second one of the network devices having determined at least one of the network devices to apply the policy to the communication; and
responding to the communication.

12. The method of claim 11, wherein the second one of the network devices having determined at least one of the network devices to apply the policy to the communication comprises the second one of the network devices having determined a set of one or more of the network access devices that were capable of applying the policy to the communication.

13. The method of claim 11, wherein the second one of the network devices having determined at least one of the network devices to apply to the policy to the communication comprises the second one of the network devices having determined workloads of one or more of the network access devices.

14. The method of claim 13, wherein the second one of the network devices having determined at least one of the network devices to apply to the policy to the communication further comprises the second one of the network devices having determined one of the one or more network devices that was idlest based on its workload.

15. The method of claim 11, wherein a network device is downstream from an other network device if network traffic passes through the network device before arriving at the other network device.

16. The method of claim 11, wherein at least two of the network access devices established a trust relationship.

17. The method of claim 11, wherein the policy is included in a central repository accessible by each of the network access devices.

18. In a computing environment, an apparatus, comprising:
a communications mechanism operable to receive a communication between a first and a second node;
capabilities detector operable to determine network traffic processing capabilities;
an upstream/downstream communicator operable to send and receive network traffic processing capabilities, metadata regarding the communication, and requests to perform network traffic processing to and from an other entity outside the apparatus via the communications mechanism;
a policy component operable to determine a policy to apply to the communication; and
a network traffic inspector operable to process the communication according to the policy.

19. The apparatus of claim 18, wherein the other entity and the apparatus comprise network access devices through which the communication passes to travel between the first and second nodes.

20. The apparatus of claim 18, wherein the upstream/downstream communicator is further operable to determine whether the network traffic inspector or an external network traffic inspector are to process the communication according to the policy.
